(19) United States
(12) Patent Application Publication
(10) Pub. No.: US 2026/0202047 A1
(43) Pub. Date: Jul. 16, 2026

(54) ROTARY KNOB SWITCH LAMP HOLDER

(71) Applicant: Rich Brand Industries Limited, Dongguan City (CN)

(72) Inventor: Toucai Huang, Dongguan City (CN)

(21) Appl. No.: 19/025,031

(22) Filed: Jan. 16, 2025

(51) Int. Cl. F21V 23/04; F21V 23/00; H01H 3/34; H01H 19/14; H01H 19/46

(52) U.S. Cl. CPC F21V 23/04; F21V 23/002; H01H 3/34; H01H 19/14; H01H 19/46

(57) ABSTRACT

A rotary knob switch lamp holder is disclosed. It features combined use of hook, assisting hook, and stopping edge to limit the position of the power cord from top and bottom. The cathode power connecting plate and anode power connecting plate are firmly assembled inside the big housing slot and side housing slot of the main casing to firmly clamp the inserted power cord, so as to ensure safe use of electricity. The invention creatively adopts different ways of electric power conduction to realize the function of three-stage brightness control.

### BACKGROUND OF THE INVENTION

The present invention relates to a rotary knob switch lamp holder, and more particularly to a rotary knob switch lamp holder that can ensure safe use of electricity by limiting the position of the power cord and firmly clamp the power cord to prevent disconnection.

### DESCRIPTION OF THE RELATED ART

Accordingly, the two electrodes of a conventional lamp holder are respectively connected with the two electrodes of a power cord, and the power cord is then connected to the commercial power supply. The main body of the lamp holder is installed with a switch in the form of a rotary knob, used to control the connection between the lamp holder and commercial power supply. Inside the lamp holder, there is a connecting part (such as a screw holder) to be connected with a lighting component (such as a light bulb). After the lighting component is screwed into the connecting part, the two electrodes of the lighting component are respectively connected with the two electrodes of the lamp holder. Thus, the rotary knob switch can be used to turn on or off the lighting component on the lamp holder. As this kind of lamp holder is configured with the rotary knob switch, it is called “rotary knob switch lamp holder”.

The structure of conventional rotary knob switch lamp holders has evolved over the time. In early times, the power cords are connected with the lamp holder by winding the peeled end on a tightening screw. Later, the connection by simply inserting the peeled tip of the power cord becomes more convenient. However, a shortcoming is discovered. As we know, the naked wire section of the wire tip after stripping has a smooth surface, and inside the lamp holder, a bent plate is configured to catch the naked wire end, pressing the naked wire section to prevent it from separation. Because the bent plate itself does not have a structure to reinforce the connection, although initially the naked section of the power cord tip can be connected with the bent plate, once a pulling force is applied, the power cord can be easily separated from the bent plate, causing troubles of examination and repair.

### SUMMARY OF THE INVENTION

In view of the above drawback, the present invention is further researched and improved. Therefore, it is a primary objective of the present invention to provide a rotary knob switch lamp holder that can ensure safe use of electricity by limiting the position of the power cord and firmly clamp the power cord to prevent disconnection when connecting the power cord with the lamp holder.

To achieve the above-mentioned objective, the present invention is to provide a rotary knob switch lamp holder, comprising a main casing, a covering plate, a cathode power connecting plate, an anode power connecting plate, a first conducting plate, a second conducting plate, a rotary knob mechanism and a threaded collar, wherein, a pair of erected hooks are defined upright inside the top surface of the main casing, an assisting hook is respectively formed on the front edges of the bottoms of the hooks, a stopping edge is configured on the top surface of the main casing corresponding to the front of the hook, an inserting slot is provided near the side of each hook, the bottom edge of the main casing is upward to form a through slot communicating with the outside, the bottom surface of the main casing is inward to form a big housing slot located in the center and two side housing slots located on the left and right sides, the through slot passes through one of the side housing slots and further communicates with the big housing slot and the bottom surface of the main casing is inward to form a pair of engaging slots;

a central through hole is provided on the covering plate and a through slot is respectively configured on the front and back sides thereof, wherein an engaging hole and a penetrating hole are respectively configured on the two sides of the central through hole;

the cathode power connecting plate from top to bottom is provided with a clamping section the front end is concaved to form a concave contacting slot, the rear end is bent downward to upright form a base section, the bottom end of the base section is further bent to form a connecting section with an engaging hole on the end;

the anode power connecting plate from top to bottom is provided with a clamping section with a concave contacting slot on the front end, the rear end is bent downward to upright form a resisting plate and the center of the resisting plate is punched to form a backward inclining first guided connecting plate;

the first conducting plate from top to bottom is provided with a frontward inclining second guided connecting plate, the rear end is formed to be a resisting plate and then moves forward for a section to further move downward to upright form a guided touching plate;

the second conducting plate is a conductive material and a third guided connecting plate is defined from top to bottom, the rear end is bent forward for a section and then resists backward to form a resisting plate with a connecting hole, and then, the rear end of the resisting plate is inclined downward to form a guided touching plate;

the rotary knob mechanism comprises a rotary rod, an insulated rotor and a rotor conducting plate, an end of the rotary rod is inserted into the center of the insulated rotor to be secured, the rotor conducting plate is enclosed to form a housing space from the wall body and the bent outer wall, the outer wall is divided into a first contacting plate, second contacting plate, third contacting plate and an empty part, sequentially arranged in the form of a ratchet, the insulated rotor fits into the housing space of the rotor conducting plate to form a combined status, the outer wall of the insulated rotor is distributed in the form of a ratchet, sequentially forming a first ratchet, a second ratchet, a third ratchet and a fourth ratchet;

the threaded collar is a conductive material, the ring wall is configured with a threaded circle, an open slot is configured on the top surface and a connecting hole is respectively configured on the two sides of the open slot; and

while assembly, the clamping section and the base section of the cathode power connecting plate is penetrated and fitted into one of the side housing slots of the main casing, thereby enabling the concave contacting slot of the clamping section to be positioned inside one of the inserting slots, and then, the anode power connecting plate is placed in from one side of the big housing slot, thereby enabling the resisting plate of the anode power connecting plate to be inserted into the thin slot inside the big housing slot and the concave contacting slot of the clamping section to be positioned inside the other inserting slot, and the first guided connecting plate of the anode power connecting plate is rested inside the big housing slot, and further the first conducting plate is placed in from the other side of the big housing slot, thereby enabling the resisting plate of the first conducting plate to be inserted into the thin slot inside the big housing slot and the second guided connecting plate of the first conducting plate to be rested inside the big housing slot, and further, the rotary knob mechanism is placed in the big housing slot, the side housing slot and the through slot, and the part of the rotor conducting plate enclosing the insulated rotor enters into the space enclosed by the first guided connecting plate and the second guided connecting plate, and then, the guided touching plate of the second conducting plate is placed in from one of the through slots of the covering plate and further a connecting piece passes through the engaging hole and the central through hole to be secured, and then, the covering plate covers the main casing to enable the third guided connecting plate to surround the rotor conducting plate, and then, the screw holder is provided on the bottom of the covering plate, thereby enabling the central through hole and through slot of the covering plate to enter into the open slot, and meanwhile the two connecting holes are aligned one by one to the engaging slots of the covering plate, and a connecting piece passes through the connecting hole and the engaging slot to be secured.

According to the above-mentioned rotary knob switch lamp holder, wherein an engaging slot is enclosed by a raised block, during assembly, the block is pressed into the penetrating hole of the covering plate, and the connecting section of the cathode power connecting plate is pressed against the block.

According to the above-mentioned rotary knob switch lamp holder, wherein the central through hole and through slot of the covering plate are configured on a block, and during assembly, the block of the covering plate is pressed into the open slot of the threaded collar.

According to the above-mentioned rotary knob switch lamp holder, wherein a resisting wall is erected on the top surface of the covering plate, and during assembly, the resisting wall fits into the big housing slot to support the resisting plate of the first conducting plate.

### BRIEF DESCRIPTION OF THE DRAWINGS

FIG. 1 is a perspective view of the present invention.

FIG. 2 is an exploded perspective view 1 of the present invention.

FIG. 3 is an exploded perspective view 2 of the present invention.

FIG. 4 is a top view of the present invention showing completion of the power connection between the power cord and the main casing.

FIG. 5 is a bottom view of the present invention showing completion of assembly between the main casing and the cathode power connecting plate, anode power connecting plate, first conducting plate, and rotary knob mechanism.

FIG. 6 is a side sectional view of the present invention showing power connection after the assembly.

FIG. 7 is a front sectional view of the present invention showing power connection after the assembly.

FIG. 8 is an exploded perspective view of the present invention and the light bulb.

FIG. 9 is a sectional front view of the present invention showing the power is connected when a light bulb is screwed.

FIG. 10~FIG. 13 are operational views of the present invention showing extinguishing and three-stage brightness control.

### DETAILED DESCRIPTION OF EMBODIMENTS OF THE INVENTION

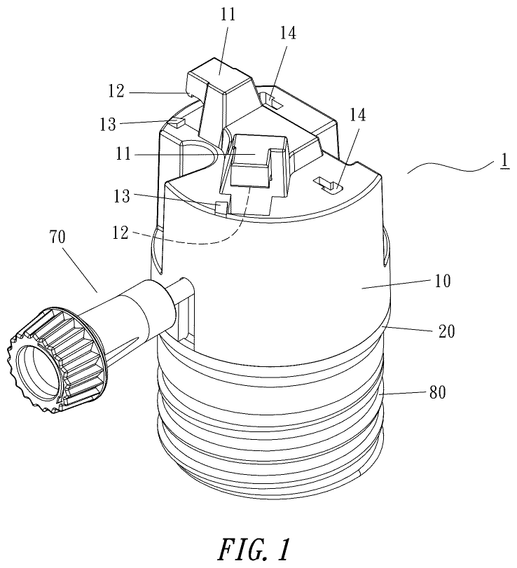

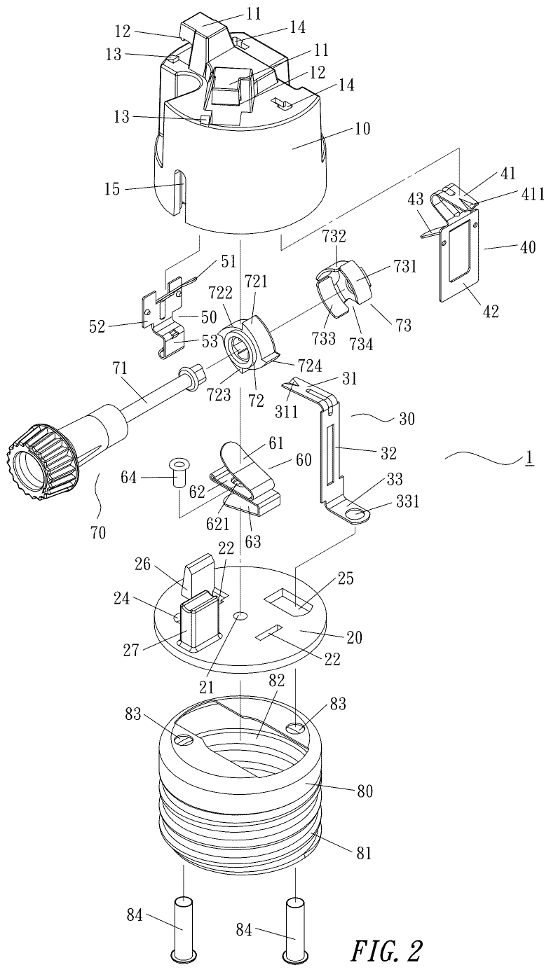

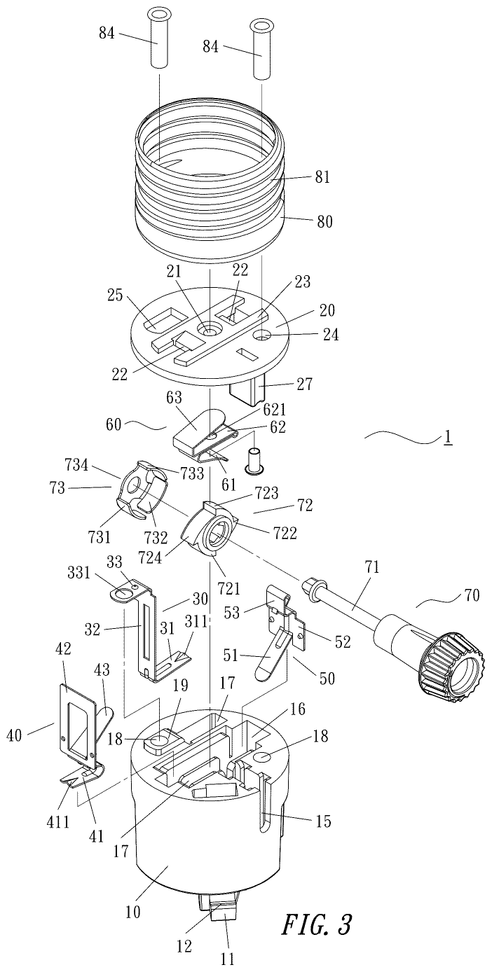

1 For better understanding of the technical means to achieve the above object and the effects of the present invention to be accomplished, detailed descriptions are provided below with respect to the following preferred embodiment and with reference to the accompanying figures. With reference to FIGS. 1 to 5, the present invention is a rotary knob switch lamp holder 1, comprising a main casing 10, a covering plate 20, a cathode power connecting plate 30, an anode power connecting plate 40, a first conducting plate 50, a second conducting plate 60, a rotary knob mechanism 70 and a threaded collar 80, wherein the main casing 10 and the covering plate 20 are a non-conductive material, the rotary knob mechanism 70 is partly conductive and partly non-conductive, the cathode power connecting plate 30, the anode power connecting plate 40, the first conducting plate 50, the second conducting plate 60, and the threaded collar 80 are all of conductive materials. On the top surface of the main casing 10, there is a pair of erected hooks 11. The bodies of the hooks 11 face downward, and the bodies of the two hooks 11 are back to back. The front edges of the bottoms of the hook bodies are respectively formed with an assisting hook 12. Relative to the front of the hook 11, a stopping edge 13 is configured on the top surface of the main casing 10. Beside each hook 11, an inserting slot 14 is provided. On the bottom edge of the main casing 10, an upward through slot 15 is provided, communicating with the outside. On the bottom surface of the main casing 10, a big housing slot 16 located in the center and two side housing slots 17 located on the left and right sides are provided in an inward form. The through slot 15 passes through one of the side housing slots 17 and is communicated with the big housing slot 16. In addition, on the bottom surface of the main casing 10, a pair of engaging slots 18 is provided, wherein one engaging slot 18 is enclosed by a raised block 19.

The covering plate 20 is in the form of a round plate, having a corresponding diameter to cover the bottom edge of the main casing 10. On the covering plate 20, a central through hole 21 is provided, and on its front side and back side, a through slot 22 is respectively configured. The central through hole 21 and the through slots 22 are configured on a raised block 23. On the two sides of the block 23, an engaging hole 24 and a penetrating hole 25 are respectively provided. On the top surface of the covering plate 20, and beside one a through slot 22, a resisting wall 26 is erected. In addition, at the position corresponding to the through slot 15, a supporting block 27 is erected.

The cathode power connecting plate 30 is made by die-cutting and bending a plate. From top to bottom, there is a slightly downward inclining clamping section 31, with the tip of its front end formed with a concave contacting slot 311, and its rear end bent vertically downward to form a base section 32. The bottom end of the base section 32 is bent again to form a connecting section 33, with its tip configured with an engaging hole 331. The connecting hole 331 is relative to one of the engaging slots 18 on the main casing 10.

The anode power connecting plate 40 is made by punching and bending a plate. From top to bottom, there is a slightly downward inclining clamping section 41, with the tip of its front end formed with a concave contacting slot 411, and its rear end bent downward and then backward to form a resisting plate 42. The center of the resisting plate 42 is punched to form a backward inclining first guided connecting plate 43.

The first conducting plate 50 is made by die-cutting and bending a plate. From top to bottom, there is a front-inclining second guided connecting plate 51, with its rear end forming a vertically downward resisting plate 52, which is then bent forward for a small section and then vertically downward to form a guided touching plate 53, whose rear end is further bent to increase the strength.

The second conducting plate 60 is made by punching and bending a plate. From top to bottom, there is a third guided connecting plate 61, with its rear end bent forward for a section and then tightly folded backward to form a resisting plate 62, which is configured with a connecting hole 621. Then, the rear end of the resisting plate 62 is inclined downward to form a guided touching plate 63.

The rotary knob mechanism 70 comprises a rotary rod 71, an insulated rotor 72, and a rotor conducting plate 73. The rotary rod 71 and the insulated rotor 72 are of a non-conductive material. The rotor conducting plate 73 is of conductive material. A tip of the rotary rod 71 can be inserted into the center of insulated rotor 72 and be fixed. Thus, when the rotary rod 71 is turned, the insulated rotor 72 can be driven to rotate simultaneously. The rotor conducting plate 73 is formed with a housing space, enclosed by the wall body and the bent outer wall. The outer wall is divided into four equal parts, wherein three equal parts are arranged in the form of a ratchet and sequentially formed with a first contacting plate 731, a second contacting plate 732, and a third contacting plate 733, while the fourth equal part is empty 734. The insulated rotor 72 can fit into the housing space of the rotor conducting plate 73 to collectively form a tightly touched and connected state. The outer walls of the insulated rotor 72 are distributed in the form of a ratchet, sequentially forming a first ratchet 721, a second ratchet 722, a third ratchet 723, and a fourth ratchet 724.

The ring wall of the threaded collar 80 is configured with threaded circle 81. On the top surface, an open slot 82 is configured. On the two sides of the open slot 82, a connecting hole 83 is respectively configured.

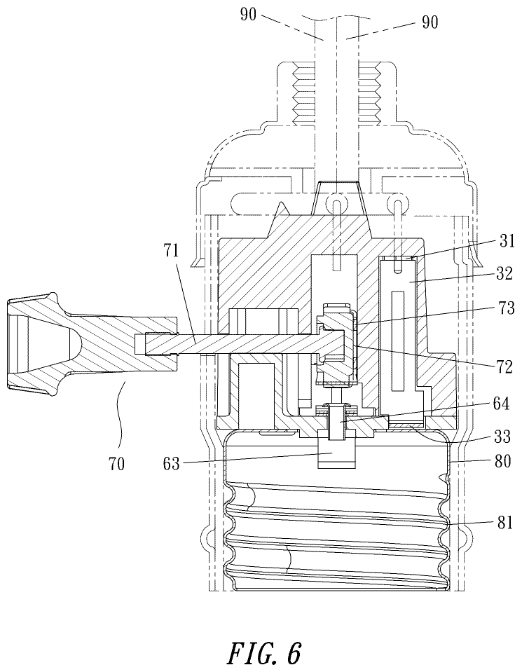

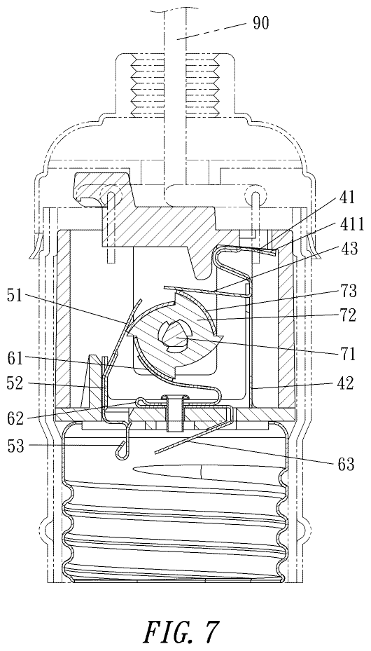

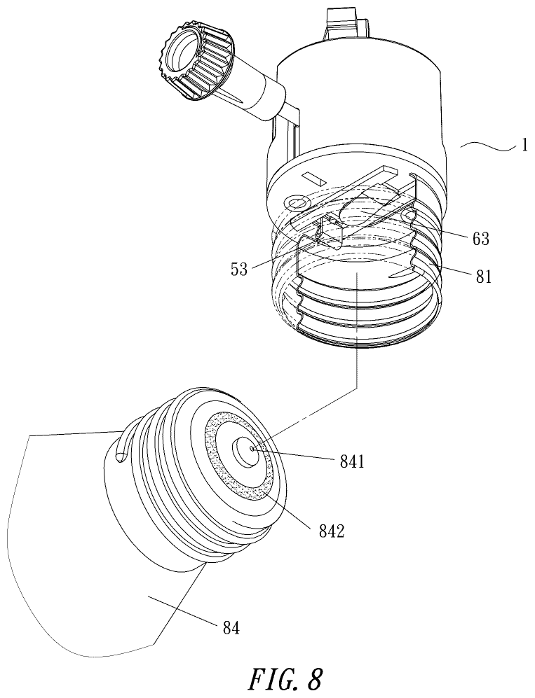

As shown in FIGS. 6 and 7, the assembly of the rotary knob switch lamp holder 1 is to fit the clamping section 31 and the base section 32 of the cathode power connecting plate 30 into either of the side housing slots 17 of the main casing 10, until the concave contacting slot 311 of the clamping section 31 is positioned inside either of the inserting slots 14. The connecting section 33 is pressed against the block 19, and the engaging hole 331 is aligned to the engaging slot 18. Then, the anode power connecting plate 40 from one side is put into the big housing slot 16, until the resisting plate 42 of the anode power connecting plate 40 is inserted into and clamped by the thin slot extended from inside the big housing slot 16, so that the concave contacting slot 411 of the clamping section 41 is positioned inside the other inserting slot 14, and the first guided connecting plate 43 of the anode power connecting plate 40 is suspended inside the big housing slot 16.

The first conducting plate 50 is put in from the other side in the big housing slot 16, until the resisting plate 52 of the first conducting plate 50 is inserted into and clamped by the thin slot extended from inside the big housing slot 16, so that the second guided connecting plate 51 of the first conducting plate 50 is suspended inside the big housing slot 16, while the guided touching plate 53 of the first conducting plate 50 is suspended outside the main casing 10. Then, the rotary rod 71, the insulated rotor 72, and the rotor conducting plate 73 are assembled into the rotary knob mechanism 70, and put the rotary knob mechanism 70 into the big housing slot 16, the side housing slot 17 and the through slot 15, and the part of the rotor conducting plate 73 enclosing the insulated rotor 72 is placed into the space enclosed by the first guided connecting plate 43 and the second guided connecting plate 51.

The guided touching plate 63 of the second conducting plate 60 is put in from a tilted direction from either of the through slots 22 of the covering plate 20, until the connecting hole 621 is aligned to the central through hole 21 of the covering plate 20. After this, a connecting piece 64 can be put through the connecting hole 621 and the central through hole 21 for fixation. Then, the covering plate 20 is covered together with the second conducting plate 60 onto the main casing 10, so that the third guided connecting plate 61 is positioned around the rotor conducting plate 73. The guided touching plate 63 of the second conducting plate 60 is suspended outside. The penetrating hole 25 of the covering plate 20 perfectly allows the block 19 to press in and be suspended, and the other engaging slot 18 is communicated with the connecting hole 24 of the covering plate 20, and the guided touching plate 53 of the first conducting plate 50 goes through the other through slot 22 of the covering plate 20 and is suspended outside the covering plate 20. The resisting wall 26 of the covering plate 20 goes into the big housing slot 16 to support the resisting plate 52 of the first conducting plate 50, and the supporting block 27 of the covering plate 20 goes into the through slot 15 to hold the rotary rod 71. Then, the threaded collar 80 is attached to the bottom of the covering plate 20, until the block 23 of the covering plate 20 is pressed into the open slot 82 and be suspended. The two engaging holes 83 are perfectly aligned one by one to the engaging slots 18a of the covering plate 20. A connecting piece 84 can go through the engaging hole 83 and the engaging slot 18 for fixation. By now, the assembly of the rotary knob switch lamp holder 1 is completed. The external part of the rotary knob switch lamp holder 1 must be mounted with a cap and an outer wall for insulation. This is not detailed herein because it is not in connection with the features of the present invention.

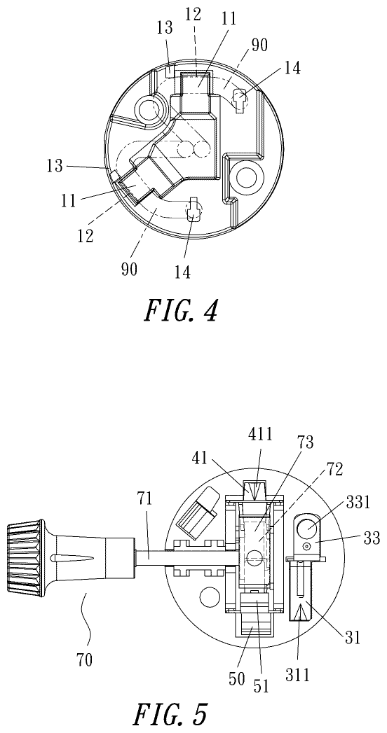

Before actual use of the rotary knob switch lamp holder 1 of the present invention, the connection of the power cord must be completed. As shown in FIGS. 4, 6 and 7, the tip of the power cord 90 introduced from commercial power supply must be stripped for a small section to form a naked section. Then, the naked section of the power cord 90 is put through an insulated top cover from the topside, and the two power cords 50 and wind the two power cords 50 are separated respectively under the two hooks 11 of the main casing 10 to be pressed. The power cord 90 is caught between the assisting hook 12 and the stopping edge 13 and is limited, i.e., the assisting hook 12 and the stopping edge 13 cooperate with the hook 11 to clamp the power cord 90 from top and bottom, and limit its position to prevent it from falling off. Then, the naked section of the power cord 90 is inserted downward along the corresponding inserting slot 14 located beside. The naked sections of the two power cords 90 respectively contact the clamping section 31 of the cathode power connecting plate 30 and the clamping section 41 of the anode power connecting plate 40. A force is applied to further insert the naked section of the power cord 90 toward the corresponding inserting slot 14. The naked sections of the power cords 90 respectively push apart the clamping sections 31, 41 and go further in. The recovering force of the clamping sections 31, 41 is respectively applied upon the naked section of the power cord 90 from the concave contacting slots 311, 411. By now, the power connection of the rotary knob switch lamp holder 1 is completed.

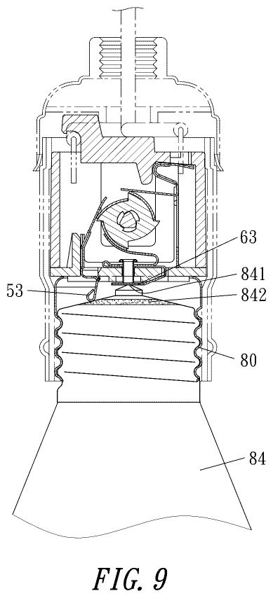

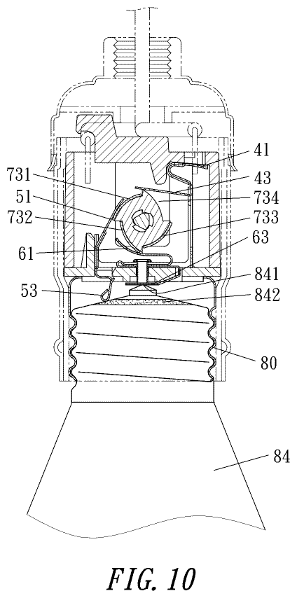

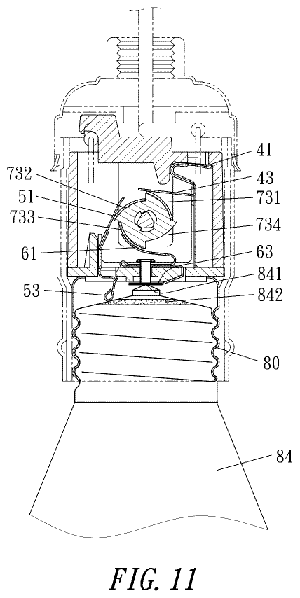

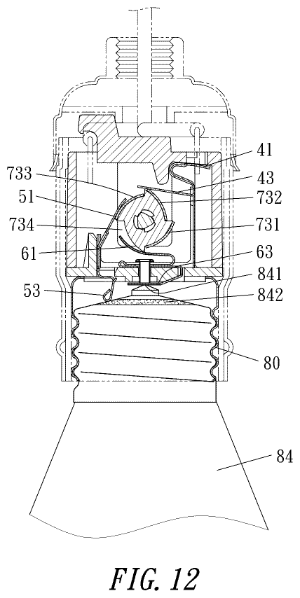

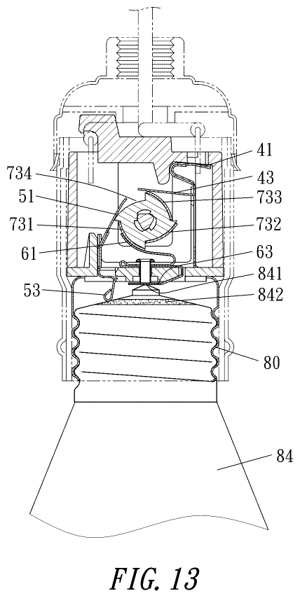

After completion of the power connection, the rotary knob switch lamp holder 1 of the present invention can be connected with a lighting component. As shown in FIGS. 8 and 9, the top of a light bulb 84 has a screw head. The external thread of the screw head can be screwed into the threaded collar 80. The top end of the screw head has a conductive point 841, and a conductive ring 842 is configured at a distance slightly outward. The conductive ring 842 is insulated from both the external threaded part of the screw head and the conductive point 841. When the screw head is screwed into the threaded collar 80, the external threaded part of the screw head is connected with the screw holder 80 and is conducted to the cathode power connecting plate 30. Then, when the screw head is screwed to the end point, the conductive point 841 is conducted with the guided touching plate 63. The conductive ring 842 is conducted with the guided touching plate 53. The conductive point 841 and the conductive ring 842 are the external conducting points of the two lighting circuits inside the light bulb 84. The conductive ring 842 and the threaded collar 80 form the first lighting circuit, while the conductive point 841 and the threaded collar 80 form the second lighting circuit. However, how to CLOSE or OPEN the conduction of the guided touching plate 63 and the guided touching plate 53 with the anode power connecting plate 40 is controlled by turning the rotary knob mechanism 70. When the user turns the rotary knob 71 to drive the insulated rotor 72 and the rotor conducting plate 73 to rotate, four varied statuses are generated, as shown in FIGS. 10 to 13. Specifically:
(a) When it is turned to the status as shown in FIG. 10, because the first guided connecting plate 43 of the anode power connecting plate 40 contacts the fourth ratchet 724 of the insulated rotor 72, i.e., the empty part 734 of the rotor conducting plate 73, electric current cannot be conducted from the first guided connecting plate 43. Therefore, the whole rotary knob switch lamp holder 1 is in the OFF status.
(b) When the rotary knob 71 is turned for 90 degrees from the status shown in FIG. 10 to the status as shown in FIG. 11, the first guided connecting plate 43 of the anode power connecting plate 40 contacts the first contacting plate 731 of the rotor conducting plate 73. The second guided connecting plate 51 of the first conducting plate 50 contacts the second contacting plate 732 of the rotor conducting plate 73, and the third guided connecting plate 61 of the second conducting plate 60 contacts the third contacting plate 733 of the rotor conducting plate 73. Therefore, the electric current of the anode power connecting plate 40 is conducted to the guided touching plate 53 of the first conducting plate 50. The electric is also conducted to the guided touching plate 63 of the second conducting plate 60. Thus, the first lighting circuit connected to the conductive ring 842 is powered and lighted up. The second lighting circuit connected to the conductive point 841 is also powered and lighted up. As a result, the rotary knob switch lamp holder 1 is in the status of first brightness (such as high brightness).
(c) When the rotary knob 71 is rotated for 90 degrees from the status shown in FIG. 11 to the status shown in FIG. 12, the first guided connecting plate 43 of the anode power connecting plate 40 contacts the second contacting plate 732 of the rotor conducting plate 73, and the second guided connecting plate 51 of the first conducting plate 50 contacts the third contacting plate 733 of the rotor conducting plate 73. The third guided connecting plate 61 of the second conducting plate 60 contacts the fourth ratchet 724 of the insulated rotor 118. Thus, the electric current of the anode power connecting plate 40 is conducted to the guided touching plate 53 of the first conducting plate 50, and the first lighting circuit connected to the conductive ring 842 is powered and lighted up with second brightness (such as middle brightness).
(d) When the rotary knob 71 is turned for 90 degrees from the status as shown in FIG. 12 to the status shown in FIG. 13, the first guided connecting plate 43 of the anode power connecting plate 40 contacts the third contacting plate 733 of the rotor conducting plate 73, and the third guided connecting plate 61 of the second conducting plate 60 contacts the first contacting plate 731 of the rotor conducting plate 73. The second guided connecting plate 51 of the first conducting plate 50 contacts the fourth ratchet 724 of the insulated rotor 118. Thus, the electric current of the anode power connecting plate 40 is conducted to the guided touching plate 63 of the second conducting plate 60, and the second circuit connected to the conductive point 841 is powered and lighted up with third brightness (e.g., low brightness). Then, when the rotary knob 71 is turned for 90 degrees once more, it returns to the status as shown in FIG. 10. In this way, the rotation is cycled.

As indicated in the above descriptions, the present invention creatively uses the combination of the hook 11, and the assisting hook 12 and the stopping edge 13 to limit the position of the power cord 90 from top and bottom to prevent it from falling off. The invention creatively provides the cathode power connecting plate 30 and the anode power connecting plate 40, which are firmly assembled inside the big housing slot 16 and side housing slot 17 of the main casing 10 and which firmly clamp the power cord 90 inserted in from the inserting slot 14. In this way, the power cord 90 is limited and firmly fixed. Because the power cord 90 is firmly clamp, separation between the power cord 90 and the cathode power connecting plate 30 and the anode power connecting plate 40 can be avoided to ensure safe use of electricity. The present invention creatively adopts different ways of electric power conduction to realize the function of three-stage brightness control.

In summary, the present invention not only has novelty, but also has value for industrial utilization. Therefore, an application for invention patent is submitted. Your examination and approval will be highly appreciated.

What is claimed is:

1. A rotary knob switch lamp holder, comprising:
a main casing, a covering plate, a cathode power connecting plate, an anode power connecting plate, a first conducting plate, a second conducting plate, a rotary knob mechanism and a threaded collar, wherein a pair of erected hooks are defined upright inside a top surface of the main casing, an assisting hook is respectively formed on the front edges of the bottoms of the hooks, a stopping edge is configured on the top surface of the main casing corresponding to the fronts of the hooks, an inserting slot is provided near a side of each hook, a bottom edge of the main casing is upward to form a through slot communicating with the outside, the bottom surface of the main casing is inward to form a big housing slot located in a center and two side housing slots located on the left and right sides, the through slot passes through one of the side housing slots and further communicates with the big housing slot and the bottom surface of the main casing is inward to form a pair of engaging slots;
a central through hole is provided on the covering plate and a through slot is respectively configured on the front and back sides thereof, wherein an engaging hole and a penetrating hole are respectively configured on the two sides of the central through hole;
the cathode power connecting plate from top to bottom is provided with a clamping section, the front end is concaved to form a concave contacting slot, the rear end is bent downward to upright form a base section, the bottom end of the base section is further bent to form a connecting section with an engaging hole on the end;
the anode power connecting plate from top to bottom is provided with a clamping section with a concave contacting slot on the front end, the rear end is bent downward to upright form a resisting plate and the center of the resisting plate is punched to form a backward inclining first guided connecting plate;
the first conducting plate from top to bottom is provided with a frontward inclining second guided connecting plate, a rear end is formed to be a resisting plate and then moves forward for a section to further move downward to upright form a guided touching plate;
the second conducting plate is a conductive material and a third guided connecting plate is defined from top to bottom, a rear end is bent forward for a section and then resists backward to form a resisting plate with a connecting hole, and then, the rear end of the resisting plate is inclined downward to form a guided touching plate;
the rotary knob mechanism comprises a rotary rod, an insulated rotor and a rotor conducting plate, an end of the rotary rod is inserted into a center of the insulated rotor to be secured, the rotor conducting plate is enclosed to form a housing space from a wall body and a bent outer wall, the outer wall is divided into a first contacting plate, second contacting plate, third contacting plate and an empty part, sequentially arranged in a form of a ratchet, the insulated rotor fits into the housing space of the rotor conducting plate to form a combined status, an outer wall of the insulated rotor is distributed in the form of a ratchet, sequentially forming a first ratchet, a second ratchet, a third ratchet and a fourth ratchet;
the threaded collar is a conductive material, a ring wall is configured with a threaded circle, an open slot is configured on a top surface and a connecting hole is respectively configured on the two sides of the open slot; and
while assembly, the clamping section and the base section of the cathode power connecting plate is penetrated and fitted into one of the side housing slots of the main casing, thereby enabling the concave contacting slot of the clamping section to be positioned inside one of the inserting slots, and then, the anode power connecting plate is placed in from one side of the big housing slot, thereby enabling the resisting plate of the anode power connecting plate to be inserted into the thin slot inside the big housing slot and the concave contacting slot of the clamping section to be positioned inside the other inserting slot, and the first guided connecting plate of the anode power connecting plate is rested inside the big housing slot, and further the first conducting plate is placed in from the other side of the big housing slot, thereby enabling the resisting plate of the first conducting plate to be inserted into the thin slot inside the big housing slot and the second guided connecting plate of the first conducting plate to be rested inside the big housing slot, and further, the rotary knob mechanism is placed in the big housing slot, the side housing slot and the through slot, and the part of the rotor conducting plate enclosing the insulated rotor enters into the space enclosed by the first guided connecting plate and the second guided connecting plate, and then, the guided touching plate of the second conducting plate is placed in from one of the through slots of the covering plate and further a connecting piece passes through the engaging hole and the central through hole to be secured, and then, the covering plate covers the main casing to enable the third guided connecting plate to surround the rotor conducting plate, and then, the screw holder is provided on the bottom of the covering plate, thereby enabling the central through hole and through slot of the covering plate to enter into the open slot, and meanwhile the two connecting holes are aligned one by one to the engaging slots of the covering plate, and a connecting piece passes through the connecting hole and the engaging slot to be secured.

2. The rotary knob switch lamp holder of claim 1, wherein an engaging slot is enclosed by a raised block, during assembly, the block is pressed into the penetrating hole of the covering plate, and the connecting section of the cathode power connecting plate is pressed against the block.

3. The rotary knob switch lamp holder of claim 1, wherein the central through hole and through slot of the covering plate are configured on a block, and during assembly, the block of the covering plate is pressed into the open slot of the threaded collar.

4. The rotary knob switch lamp holder of claim 1. wherein a resisting wall is erected on the top surface of the covering plate, and during assembly, the resisting wall fits into the big housing slot to support the resisting plate of the first conducting plate.
